(19) United States
(12) Patent Application Publication
(10) Pub. No.: US 2008/0071594 A1
(43) Pub. Date: Mar. 20, 2008

(54) System and method for auctioning product placement opportunities

(76) Inventor: Joseph Morin, Irvine, CA (US)

Correspondence Address: MORRISON & FOERSTER LLP, 755 PAGE MILL RD, PALO ALTO, CA, 94304-1018, US

(21) Appl. No.: 11/893,165

(22) Filed: Aug. 14, 2007

Related U.S. Application Data
(60) Provisional application No. 60/837,895, filed on Aug. 15, 2006.
(60) Provisional application No. 60/837,896, filed on Aug. 15, 2006.
(60) Provisional application No. 60/837,897, filed on Aug. 15, 2006.

(51) Int. Cl. G06Q 10/00; G06F 17/40

(52) U.S. Cl. 705/7; 705/37

(57) ABSTRACT

A method and system allowing producers of media content, for example movies, television shows, games, books, internet videos, and theater plays, to realize revenue by selling product placement opportunities to interested advertisers. These product placement opportunities are offered individually to specific advertisers, or auctioned off to interested advertisers. Advertisers are able to search for product placement opportunities to bid on, or producers of media content that contains product placement opportunities can invite advertisers to bid on their opportunities. A related computer system auctions product placement opportunities on a piece of media via a network connection such as the Internet, and product placement opportunities are bid on by advertisers. The producers of the product placement opportunities are producers of movies, games, books, or even short internet videos. Information from interested advertisers and media producers is uploaded into a database located on the computer system to be searched by users of the system, to maximize information flow and value to the users. Also provided is a method for gathering metric information on electronic media distributed across a network. This metric information can be gathered in detailed form, to better estimate the value of that electronic media to sponsors of that media, such as advertisers who purchase a product placement opportunity on future productions of that electronic media.

### CROSS REFERENCE TO RELATED APPLICATIONS

This application claims priority to U.S. Provisional Application Nos. 60/837,895, 60/837,896, and 60/837,897, all filed Aug. 15, 2006, and incorporates all of them herein by reference in their entireties.

### FIELD OF THE INVENTION

This disclosure relates in general to the field of advertising, and more specifically to product placement advertising.

### BACKGROUND OF THE INVENTION

Advertising agencies sometimes promote products (and services) by creating commercials for advertisers that viewers watch at home while waiting for a television show to continue, or for a movie to start. However, with the advances in television recording technology, users of technology that record television shows are given the ability to fast-forward through such commercials. Recent studies show that more and more users of television recording technology are skipping commercials. Therefore, the importance of other methods to expose viewers of media to advertisements is growing as commercials are watched less.

One such method is product placement. Product placement is a promotional tactic used by marketers in which a real commercial product or service is used in fictional or non-fictional media, and the presence of the product or service is a result of an economic exchange. When featuring a product is not part of an economic exchange, it is called a product plug. Product placement is a rapidly growing, but still a rather archaic industry where handshake deals and personal relationships drive the multi-billion dollar business. If an advertiser or a producer of a product placement opportunity is not well connected, many product placement opportunities may go unsold. In fact, studies show that over two thirds (⅔) of product placement opportunities go unsold. Thus, although great potential exists for product placement marketing, many opportunities are not realized with the strategies of today.

### SUMMARY

Therefore, the present inventors have identified a need for a system and method that facilitates connecting advertisers with creators of product placement opportunities. To minimize the limitations in the prior art, and to minimize other limitations that will be apparent upon the reading of the specification, the present disclosure provides a system and method for auctioning product placement opportunities.

A method in accordance with the present invention includes receiving a storyboard for a production, receiving a description of a product placement opportunity in the storyboard, providing the storyboard to an advertiser, providing the description of the product placement opportunity in the storyboard to at least one advertiser, and receiving a bid from the advertiser. (“Product placement” here also refers to service placement.) Storyboards are a series of illustrations, generated manually or using computer graphics, and displaying in sequence a part or all of an animated or live action film or video production. A storyboard is essentially a “comic strip” depiction of at least a part of the production and produced beforehand to help directors and cinematographers visualize the scene or scenes and find potential problems pre-production. Often storyboards include arrows or instructions that indicate movement.

A system in accordance with the present invention includes a server, a memory, accessible by the server, a database, residing on the memory, storing data relating to an advertiser, a product placement opportunity, and a bid that an advertiser places on the product placement opportunity, and a bidding environment, enabling at least one advertiser to bid on a product placement opportunity, a first user interface for enabling a producer to input the product placement opportunity into the database and for enabling the producer to receive information on the bid and a second user interface for enabling the advertiser to bid on the product placement opportunity.

Another method in accordance with the present invention includes monitoring a digital video shared to other computers on a network, collecting metric information on the digital video whenever the digital video is accessed by another computer, and reporting the metric information to an interested party.

It is a goal here to provide interested parties, for example media companies, with a process of selecting placement product opportunities and submitting storyboards relating to the product placement opportunities to interested parties, for example advertisers, to provide funding for projects where the product placement would occur such as in motion picture, video games, music videos, network programming or any other type of media project available in the entertainment industry.

It is another goal to provide a process that makes placement product marketing accessible to any individual interested in making a media project or placing advertising on a variety of marketing channels.

### BRIEF DESCRIPTION OF THE DRAWINGS

FIG. 1 is a flow chart describing a method of providing placement product opportunities to advertisers in a bidding (auction) environment in an embodiment.

FIG. 2 is a flow chart describing a method to submit a storyboard and receive funding by auctioning product placement opportunities in an embodiment.

FIG. 3 is a flow chart describing a method to search, select, and bid on storyboard opportunities in an embodiment.

FIG. 4 is an embodiment of a storyboard comprising illustrations of product placement opportunities for interested parties to select and bid.

FIG. 5 is a block diagram of an embodiment of a system for providing product placement opportunities to advertisers.

FIG. 6 is a block diagram of an embodiment of a server of the system shown in FIG. 5.

FIG. 7 is an embodiment of a database table comprising advertiser information.

FIG. 8 is an embodiment of a database table comprising producers of product placement opportunities.

FIG. 9 is an embodiment of a database table comprising specifically internet video producers of product placement opportunities.

FIG. 10 is an embodiment of a database table comprising product placement opportunities.

FIG. 11 is a flow chart describing a method for a user to access an inventory containing advertisers' product information and auction product placement opportunities in accordance to an embodiment.

FIG. 12 is a flow chart describing a method for users to access an inventory of product placement opportunities and bid on auctions to have their products advertised.

FIG. 13 is a schematic diagram illustrating another embodiment of a system for providing product placement opportunities in an auction environment.

FIG. 14 is a schematic diagram illustrating yet another embodiment of a system for providing product placement opportunities in an auction environment.

### DETAILED DESCRIPTION

In the following discussion addressing a number of embodiments and applications of the present invention, reference is made to the accompanying drawings that form a part hereof, which shows by way of illustration specific embodiments in which the invention may be practiced. It is to be understood that other embodiments may be utilized and changes may be made without departing from the scope of the invention.

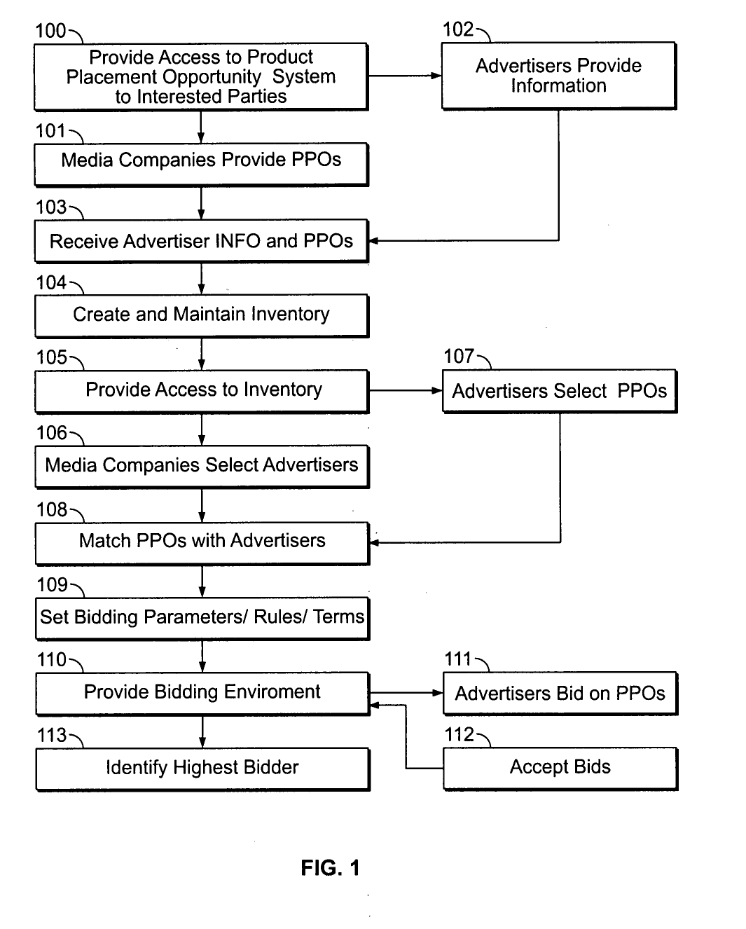

FIG. 1 is a flow chart describing a method a service provider could use to introduce product placement opportunities to advertisers and vice versa in a bidding environment in accordance with an embodiment. The method is explained in the order shown below for illustration purposes; however a person of ordinary skill in the art would be familiar with other reasonable deviations from the order specified below without departing from the scope of the present invention.

The overall process of providing product placement opportunities generally includes providing access to the system, either through membership or registration, or both, creating and maintaining an inventory of interested parties such as media producers and advertisers, providing each party access to the inventory; providing a bidding system and environment, for example an Internet based auctioning program or a live auction for parties to bid on placement opportunities, and conducting the bidding process, for example receiving bids from a number of interested parties and announcing the winning bidder.

Referring to step 100, typically a service provider first provides access to the system to interested parties, for example by using a membership or registration process for new users, and a login or ID scan for returning users. An interested party can either be a media producer who produces product placement opportunities, or an advertiser who wishes to utilize the product placement opportunity. For example, and in no way limiting the scope of the present invention, advertisers and media companies are pre-registered with at no cost. Interested parties are able to view product placement opportunities or available advertisers for free as well (discussed below). Once an auction is held for any particular product placement opportunity or a bid is placed, interested parties may need to pay a one time registration fee.

In steps 101 and 102, registered media producers and registered advertisers provide data for an inventory comprising product placement opportunities and advertiser's wishes, respectively. This information could be categorized by demographic criteria, such as the type of venue for product placement opportunities, or the type of product to be advertised for advertisers.

A product placement opportunity is not necessarily limited to video media shown on television, movie theaters, and the internet. Product placement opportunities can be varied and unique, such as billboards in a driving video game, a product used in a movie or television/radio show, posters in a music video, a mention in a book, a T-shirt worn in an internet video, a brand name shown in some electronic media, or even a trademarked slogan uttered by a main character. So long as there is potential for an advertiser to gain exposure to a viewer or a user (in the case of interactive media) of a product placement opportunity, there exists an opportunity.

In one embodiment, a product placement opportunity is portrayed in an easy-to-follow presentation. For example, in a video, a product placement opportunity could be submitted as a storyboard showing different scenes, and highlighting portions of the scenes where product placement opportunities exist. (Storyboards are a well known way of presenting ideas for entertainment and commercials.) In a video game, a product placement opportunity could be submitted as a map of a town where the game is taking place, with sections of the town blown up and highlighted where posters could be mounted, or products could be used, or even stores could be depicted. In an exemplary embodiment, these presentations are accompanied with descriptions which detail how the provider of the product placement opportunity envisions using that space to advertise.

Likewise, an advertiser's wishes do not necessarily need to be limited to placing a product or service itself in a product placement opportunity. For example, an advertiser could simply wish to advertise a website, to utter a certain slogan, to show only a portion of a product, to pay with a limited budget, to utilize a certain visual pattern, or even to utilize a service associated with a product. These are also included in what is referred to here as “product placement.”

In one embodiment, when a user, for example a consumer viewing a video where product placement opportunities have been already auctioned off and placed, views a video featuring a product placement advertisement, the video is then ‘clickable’ and the end user can then be directed to a ‘featured products’ page where the user may then see products that have been featured in the clip and may then click on those listings either for more information on the product or to purchase the item. A service provider may then participate in either a lead generation fee from the advertiser or be paid on a ‘per click’ basis from the advertiser to send traffic to their site.

In step 103, a service provider receives product placement opportunities and the information provided by advertisers. This information can be collected through a variety of methods, such as the internet, mail, phone calls, or even in person. The advertisers and media producers could deliver the information to the service provider, or the service provider can actively solicit advertisers and producers of product placement opportunities for such information.

This information is collected and organized into an inventory in step 104. In one embodiment this inventory is collected and organized in a conventional computer database or collection of databases that may be searched by category, genre, alphabetical order, or any other method of organizing and searching such a database. In another embodiment, this inventory is organized physically on paper sorted in boxes or filing cabinets, organized by type of user, genre, cost, and type of opportunity and is cross referenced using a common index.

Access to the inventory is provided to interested parties in step 105. Typically, advertisers would search for product placement opportunities where they might be able to best advertise their product via a media venue. The advertisers may peruse the entire inventory, but typically the advertiser would peruse the inventory using various organization schemes, for example perusing by product type, venue type, lowest bid price, location that media is presented, etc. If the inventory is kept on a computer database, the advertiser could search the database via standard search query modules, for example a Boolean search query.

In some rare instances, advertisers may peruse a product placement opportunity, and see a chance for a different incarnation of that product placement opportunity, or a separate product placement opportunity altogether. For example, a media producer may wish to have an actor drink from a can with the beverage's name on it, but the advertiser may wish for the actor to drink from a frosty mug with the company's name on it. Or a media producer may show a long dialog between two persons in a living room, and an advertiser may want their commercials to be playing on a television screen in the background. In these situations, an advertiser may be able to contact the media producer to suggest changing a product placement opportunity, or creating a new product placement opportunity.

Media producers may also wish to search for advertisers. Some media producers may wish to seek only certain kinds of advertisers, or only a certain quality of advertisers. Some media producers may have had an advertiser they never heard of win the auction, and may wish to look up more detailed information on this advertiser to verify reliability. Access to the inventory allows media producers and advertisers to search for product placement opportunities and information on advertisers.

Some media producers and advertisers may not wish their information to be publicly searchable by all users. In which case, they may activate a security interface that would limit accessibility to the information they put in the inventory. Users who put information into the inventory may limit access any way they wish to, for example they can specifically select certain users who have access to certain information, or restrict access to a class of users, or may require users to sign (or digitally sign via the internet) a confidentiality contract before gaining access to the information.

Referring to steps 106 and 107, once media companies and advertisers search the inventory, they can select components of the inventory that interest them. Advertisers can select product placement opportunities they would like to bid on, and media companies can select advertisers whom they would like to invite to bid. In some scenarios, media producers who have activated a security interface for product placement opportunities may wish to hold a closed auction open only to the few advertisers they so choose. Alternatively, media producers who have made their product placement opportunities public to any advertiser user may invite additional advertisers they have searched and located through the inventory. In one embodiment of the present invention, advertisers may only be invited to bid on product placement opportunities. In another embodiment, advertisers may search the inventory for product placement opportunities or to advertise their products without a private invitation. In yet another embodiment of the present invention, a service provider may offer both private and public auctions.

In step 108, the service provider generally matches advertisers with the product placement opportunities they select, and with the product placement opportunities they have been invited to. In an exemplary embodiment, advertisers and media providers do not necessarily need to peruse the inventory. The service provider will analyze the wishes of an advertiser, and “match” them with a product placement opportunity.

With this information, service provider sets bidding parameters, rules and terms in step 109 for the different auctions. Bidding parameters, rules, and terms could vary from auction to auction and could be standardized, or highly customizable, depending on the sophistication of the clients involved. Different types of auction formats known to persons of ordinary skill in the art can be utilized, such as a Dutch auction, a sealed bid auction, and an open cry auction. Some media producers may require stringent requirements from the advertisers as well, perhaps including the ability to cancel a contract with an advertiser in the event of incompetence or malfeasance.

In step 110, a service provider creates and provides a bidding environment according to the specifications created in step 109.

Whether invited to a private auction or having searched and chosen a particular storyboard, in step 111 advertisers provide their bids on product placement opportunities placed on storyboards provided by media providers, and in step 112, the service provider receives and accepts each bid. Typically, a bidding environment in step 110 remains open for a specified period of time, but many different auction formats can be used without departing from the scope of the present invention.

In step 113, the service provider typically announces the winner to the bid. These last steps may involve more complex bidding structure depending on the bidding parameters, rules or terms that will be in effect for a particular auction. For example, a winner could be announced only to the winner of the bid, and the media producer, with all others being kept in the dark.

In one embodiment advertisers and media companies are pre-registered before they log in. There would no cost to register, and there would be no cost to view the product placement opportunities, or the information about the advertisers. If a media producer wants to hold an auction for a product placement opportunity, or an advertiser wants to place a bid on a product placement opportunity, there may be a one-time registration fee.

In another embodiment, the service provider could receive as compensation a percentage of the winning bid from the media producer.

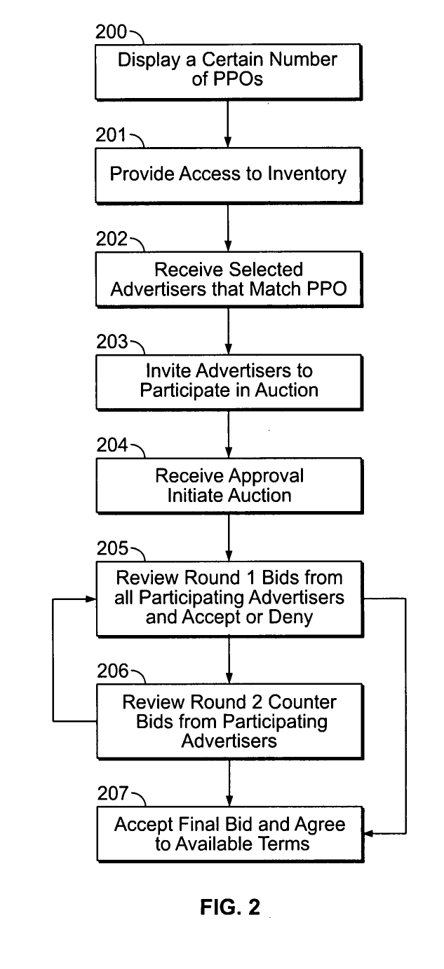

FIG. 2 is a flow chart describing a method to submit a storyboard and receive funding by auctioning product placement opportunities in accordance with an embodiment. The method is explained in the order shown below for illustration purposes; however a person of ordinary skill in the art would be familiar with other reasonable deviations from the order specified below without departing from the scope of the present invention.

The process illustrated by FIG. 2 generally includes receiving at least one storyboard from an interested party, for example a media company or a studio, providing to the media provider access to the inventory/database of advertisers and their products, receiving a selection of advertisers and products that fit storyboard, inviting advertisers of selected products to bid on product placement opportunities, receiving approval from selected advertisers, and conduct the auction of selected placement opportunities offered on provided storyboards.

Referring to step 200, interested parties provide product placement opportunities to be placed in an inventory, for example media producers who wish to auction product placement opportunities via a storyboard. The product placement opportunities may be marked, identifying the type of products that will be marketed and the scene, frame or section where each product placement opportunity will be made available for auctioning. For example, in a storyboard, a media producer may circle portions of certain scenes, describing briefly where the product placement opportunity lays, how long the potential exposure is, and what is happening in the scene.

In one embodiment, storyboards are placed into an inventory frame by frame, to be searched through and obtained in piecemeal fashion. In another embodiment an entire storyboard that is provided is placed into an inventory as a single entity. Media companies have multiple options to load frames to protect their creative concepts. In addition, multiple product placement opportunities can exist for every frame in a storyboard. The media producer may select as many product categories as he/she believes can fit into specific frames of their storyboard. The media producer may select multiple product placement opportunities per frame, scene, etc.

In step 201, access to an inventory of interested parties is provided (discussed above in step 104 of FIG. 1) to members or registered clients such as advertisers and media producers. Advertisers can search the inventory for the product placement opportunities that the media producers have placed in the inventory. Also, media producers can search for advertisers and the information they provide about what they are looking for in a product placement opportunity. Some media producers may require a certain level of sophistication from the advertisers they will let use their product placement opportunities, and so may search for “available budget,” or may individually search for well-recognized names in the industry.

In step 202, the service provider receives from the media producers a list of advertisers or specific products that the media producers have selected as best fitting their product placement opportunities. Once the product placement opportunities are loaded to the inventory, the media producer can request that a search be done to find the best possible matches of advertisers for each product placement opportunities.

In step 203, the media producer can invite advertisers to bid on a product placement opportunity. In one embodiment, the media producer receives the information about the advertiser and can send out an invitation on their own. In another embodiment, the media producer informs the service provider of their choices, and the service provider will contact the advertisers with an invitation and some information about the auction that the media producer wants to hold. In yet another embodiment, the media producer does not select any specific advertisers, but asks the service provider to send out an invitation to all potential advertisers that the service provider believes matches their product placement opportunity. In yet another embodiment, the media producer makes information about the product placement opportunity searchable by advertisers, or a subset of advertisers, who will be able to invite themselves to bid on the product placement opportunity. Many variations in the invitation scheme can be conceived by a person of ordinary skill in the art without departing from the scope of the present invention.

In step 204, advertisers chosen by media producers to bid on their product placement opportunities may respond to the invitation to participate in the auction, or advertisers may find the product placement opportunities on their own by searching the inventory (provided that the auction is made available to be searched), or a combination of the two may occur. Some media producers may wish for the auction to begin immediately and end at a certain time, whereas other media producers may wish for a certain number of advertisers to “sign up” for an auction before commencement. Other media producers may wish for an auction to only run for a limited specialized period of time and closely monitor bids and counter-bids to gauge effectiveness of the system. In another embodiment, only a limited number of advertisers are allowed to bid. In yet another embodiment, only advertisers who pass a prequalification stage may bid, for example advertisers must have a minimum budget, or a minimum “dependency rating,” or must have been specifically invited by the media producer.

In step 205 bids are collected from the various advertisers in a first round of bidding. This round may be a timed round, where many bids and counter bids can occur. In another embodiment, this is a single round of bidding, where advertisers may only bid once during the round. In yet another embodiment, a media producer will accept any bid that goes over a certain threshold, and will immediately close bidding once that price is set. Many different embodiments of auctioning are known to persons of ordinary skill in the art.

After a round of bidding is over, the bidding process may end completely, or a second round of bidding may commence.

In step 206 another round of bidding commences. This second round may commence immediately, or it may happen after some time. In one embodiment bidding advertisers are able to review the other bids that occurred in an auction, to better gauge what bid they may be up against. Some media producers may prefer this “delayed bid” type of auction over the normal “bid-rebid-rebid” embodiment, as an anxious advertiser may quote a much higher bid after knowing that he can only bid one more time. Other media producers may prefer as many rounds of bidding as possible.

After the second round of bidding is over, the bidding process may end, or yet another round of bidding may commence in a cycle that is limited by time, by a price threshold, at the discretion of an auction manager, at the discretion of the media producer, or any other threshold.

In one embodiment as bids are submitted they enter the entertainment media producer's queue. A message is delivered to the media producer indicating that the media producer has received a new bid. The media producer may accept or deny individual bids, depending on the qualifications of the bidding advertiser, may automatically allow bids from advertisers who meet a certain pre-qualification, or may automatically allow bids from all advertisers. If no bids are accepted in round 1, a round 2 bidding process is immediately opened for an advertiser to continue with the original advertiser pool, a larger pool of advertisers, or a group of replacement advertisers.

Finally, in step 207 the final bid is accepted and the media producer involved is notified of the auction's results. In one embodiment, the media producer may review all bids, and may even wish to select an advertiser with a lower bid. In another embodiment, the media producer is put in contact with the advertiser with the highest bid to negotiate terms of a contract for the product placement opportunity. If the negotiation fails, then the media producer may select an advertiser with the next highest bid and so on and so forth.

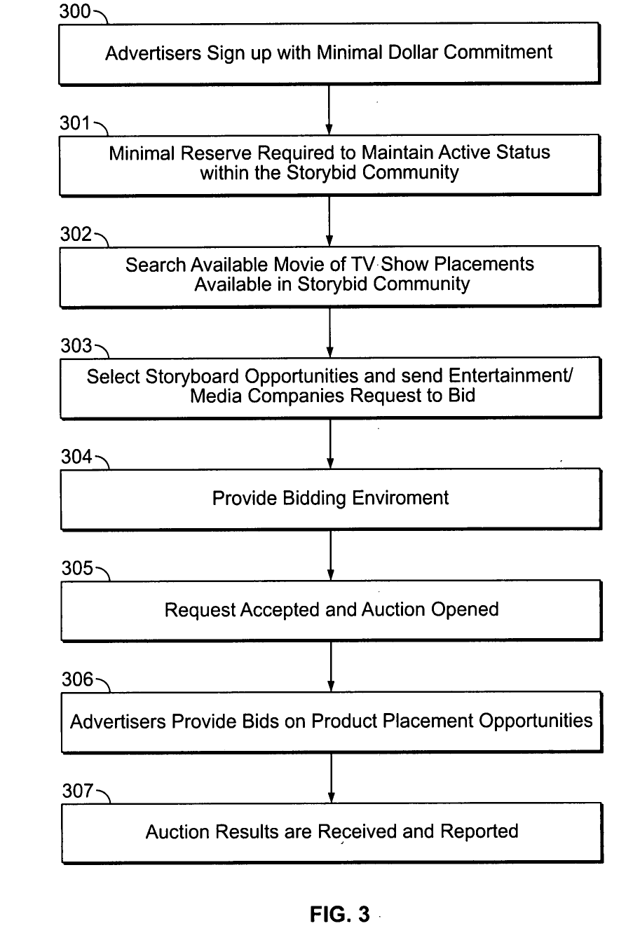

FIG. 3 is an illustration of a flow chart describing a method for an interested party, for example advertisers, to search, select, and bid on product placement opportunities in accordance with one embodiment. The method is explained in the order shown below for illustration purposes; however a person of ordinary skill in the art would be familiar with other reasonable deviations from the order specified below without departing from the scope of the present invention.

The process illustrated by FIG. 3 generally includes registering interested parties, for example advertisers, maintaining an inventory of active status advertisers, providing a searchable inventory of advertisers, for example a database of product placement opportunities, receiving a selection of product placement opportunities from advertisers, providing an auction or bidding environment to advertisers, receiving bids from advertisers, providing bids to media providers, receiving acceptance or rejections of bids, and informing advertisers of auction results.

Referring to step 300 a service provider may receive registrations from advertisers that sign up for a product placement opportunity auctioning service. In one embodiment, an advertiser can sign up for free without a commitment, and is only charged a flat rate fee once they bid on an item. In another embodiment, an advertiser is charged for every bid that they make. In yet another embodiment, the service provider collects a flat fee from the advertiser with the winning bid, or from the media producer. In yet another embodiment, the service provider collects a percentage of the winning bid. Many variations of this schema would be known to a person of ordinary skill in the art.

In one embodiment advertisers may be sold on the system and commit to active placement opportunities. In another embodiment, advertisers may sign up with a monthly or annual membership fee. For example and in no way limiting the scope of the present invention, advertisers may sign up with a minimum dollar commitment. In yet another embodiment, advertisers may sign up for free, without deviating from the scope of the present invention.

In step 301 those interested parties, are required to maintain a listing on an inventory created by the service provider. In one embodiment a financial commitment to a minimum reserve (e.g., $25,000-$100,000) depending on market segment, company size and desired ad distribution channels (i.e. large ticket film, prime time TV, etc.) will be required. In another embodiment, no commitment is required except to keep that advertiser's information available to others through the inventory.

In step 302 advertisers are provided a search of available storyboards. This search may be by category, genre, by types of product placement opportunities, names of movies, directors or artists, or any other information made available about each storyboard, without deviating from the scope of the present invention.

In an exemplary embodiment, an advertiser has the ability to search prior ad distribution through the network. In addition, they can view categories of available advertising distributions (i.e. “NBC prime time sitcom”, “FOX realty TV format”, or “mid tier movie production”).

In step 303 advertisers select at least one storyboard opportunity and send the media company (posting that storyboard) a request to bid or enter the auction for product placement opportunities displayed on the storyboard.

In an exemplary embodiment, an advertiser will have the ability to send a request to bid on existing or future projects from a specific entertainment media producer.

In step 304 advertisers are provided with a bidding environment. This environment will depend on the type of bidding that will take place. A bidding environment can include of an open cry bidding system, a Dutch auction bidding system, a sealed bid bidding system or any other type of bidding system that may be used for auctioning product placement opportunities.

In one embodiment only an open cry bidding system is used, where a product is placed for a limited amount of time (i.e. 12 hours) and everyone bidding is aware of the highest bid at any given time during the entire bidding period. In another embodiment a Dutch auction bidding system is used.

In yet another embodiment, a private bid system is used. In this system a product placement opportunity is placed for a limited time for auctioning. Each bidding party bids continuously as desired, without knowledge of who has the highest bid amount at any one point in time. Bidding parties are only aware of whether their last bid surpasses the highest bid (and not aware by how much). This confidential bidding system continues in this fashion until the end of the auctioning period, when no other party may continue to bid and the highest bidder at that point in time wins the bid.

In yet another embodiment, interested parties may decide what type of bidding system to undergo for the auctioning of their product placement opportunities.

In step 305 an auction is opened and bidding begins. In one embodiment advertisers may bid higher or lower than the opening asking price. For example, and in no way limiting the scope of the present invention, an advertiser's opening bid can be higher or lower than the opening asking price.

In step 306 advertisers provide bids to media companies. Bidding takes place in accordance with the type of bidding system the parties involved are engaged in.

Finally, in step 307, the auction results are received and reported to advertisers involved.

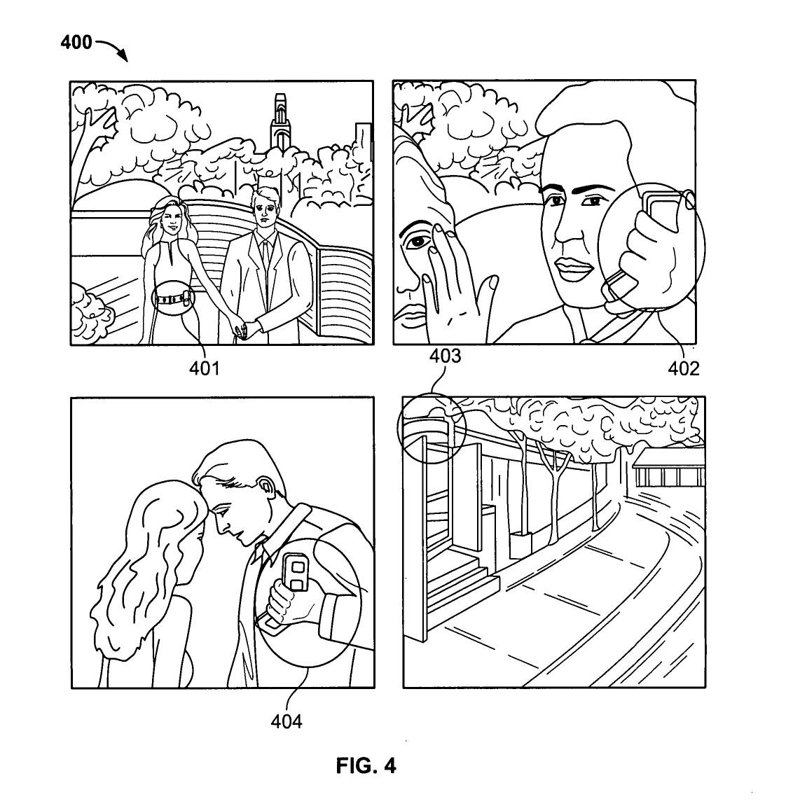

FIG. 4 is an illustration of an exemplary storyboard submitted by an interested party, for example a movie studio, containing product placement opportunities for other interested parties, for example advertisers, to select and bid in accordance with practice of the present invention.

FIG. 4 illustrates storyboard 400 and product placement opportunities 401, 402, 403, and 404.

Storyboard 400 can be any type of story board in any format in which a story board may be provided. In one embodiment, storyboard 400 is an actual drawing on storyboard material, which has been hand drafted by professional or amateur artists as a blue print to a project such as a music video, a motion picture, a theatrical performance, or any other type of project that may be executed using a storyboard.

In another embodiment, storyboard 400 is computer generated and designed by graphic artists. Storyboard 400 may be provided by an interested party on a computer file such as a PDF file or in any other medium without deviating from the scope of the present invention. For example, and in no way limiting the scope of the present invention, storyboard 400 is made using a conventional computer software illustrating program and provided to service provider or auctioneer, on a compact disc (or DVD). Additionally, storyboard 400 may be made using a software program which is provided by the service provider to interested parties, which in turn provide service provider with the completed storyboard.

Product placement opportunity 401 through 404 take place in similar scenarios of the storyline in storyboard 400. Here, product placement opportunity 401 is an opportunity for placement of a belt or similar type of garment, for example a belt with jewelry that may wrap around the woman's waist. An interested party such as a jewelry advertiser may desire to display his product on this particular scene (i.e. a scene in a motion picture).

Product placement opportunity 402 is a cell phone being held by the man in the frame of storyboard 400. For example, and in no way limiting the scope of the present invention, an interested advertiser looking to place its cell phone brand on this particular storyboard may have searched for storyboards containing product placement opportunities for these types of product, type of scene, or even the name of the actor who will be seen by viewers holding the product.

In one embodiment each one of these frames or scenes may include a description of what type of action will be occurring in the execution of the frame.

For example, and in no way limiting the scope of the present invention, the banner on top of the entrance to the establishment shown as product placement opportunity 403 or the cell phone displayed as product placement opportunity 404 may each be accompanied by descriptions of what the character will do in connection to that particular product.

The characters may, for example, eat at the restaurant establishment and say how much they enjoyed the product (in this case the food at the restaurant) placed in product placement opportunity 403, while using the cell phone (another product placement opportunity) on the next scene. This may add or subtract value from the product placement opportunity depending on the marketing strategy each advertiser is looking to implement with their products.

Finally, product placement opportunities can be as simple as placing a banner with the name of a business an advertiser desires to advertise.

In another embodiment, the advertiser originates a transaction by listing an opportunity for a content producer to bid on a product placement. In other words, an advertiser has a budget of e.g. $10,000 for product placement advertising of its product. The advertiser lists this opportunity for review by content producers. The content producers in response submit storyboards or video clips to the advertiser showing their ideas for the product placement in a production of a film or video. etc that the content producer is working on. The advertiser selects one or more of the submissions and arranges the product placement in the final version of the content. In another embodiment, the storyboarding process is modified. The creation of the storyboard is supplemented by the advertiser who lists sketches or logos relating to a product subject to product placement in a database. Content producers have access to the database. The content producers can then access the database and use the sketches or logos in their storyboard development. In this case there is not necessarily an auction, in the usual sense, of the product placement opportunity. Instead, this can be viewed as a selection process by the advertiser, and the present system serves as a platform for creation of storyboards oriented to product placements. The content producers' submissions of storyboards typically would not be made available to anyone but the advertiser, who determines which producer's submission is to be selected.

As an example of this, consider that Nike Corp. is an advertiser. Nike uploads to the present system graphical images of products (or perhaps just the Nike logo) they want to be shown in an on-line video, television program, film, book, play, etc. A content producer, with access to the database including the graphical images, can via the Internet access the present system and select the Nike graphical image. He can then drag and drop the selected image in his computer graphics created storyboard or video clip. Assume the storyboard or clip as so edited shows a newscaster wearing a T-shirt with the Nike logo. The content producer then labels the edited storyboard/clip with suitable tags such as the terms “Nike”, “T-shirt”, and “newscast.” The edited storyboard/clop is then uploaded to the present system for placement into the database, where it can be located by a search by the advertiser.

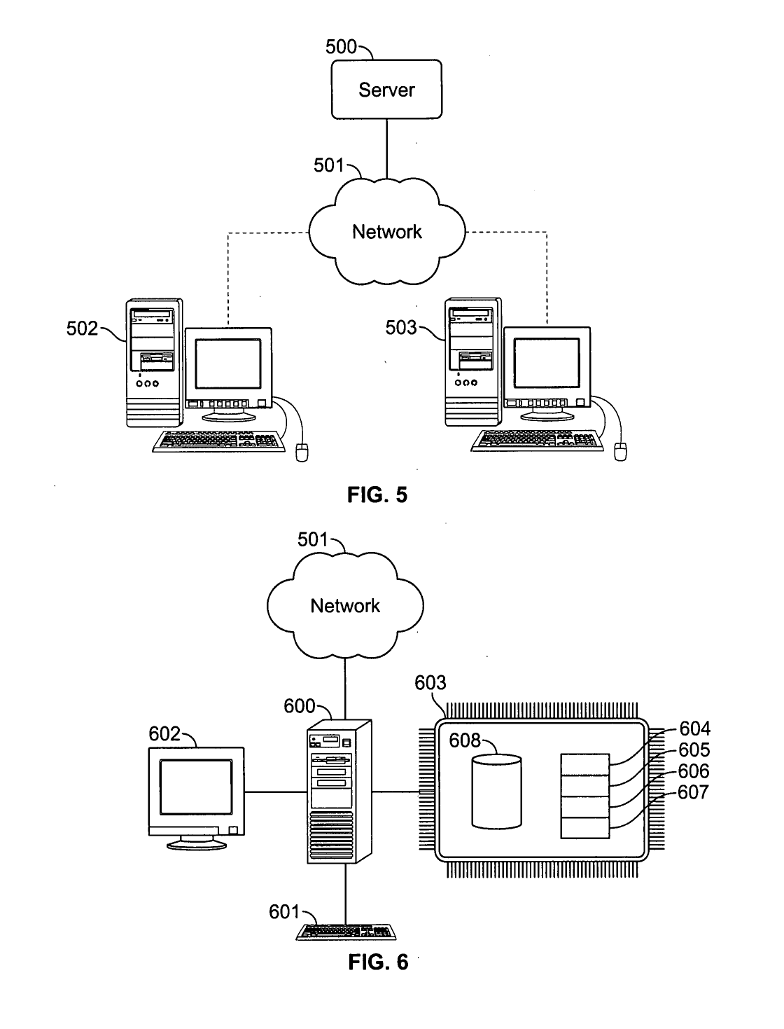

FIG. 5 illustrates a block diagram of an embodiment of a computer enabled system in accordance with the present invention, with server 500, network 501, advertiser user interface 502, and media producer interface 503. The computer hardware elements depicted are conventional. The associated computer software elements are conventional or readily coded in any convenient computer language given the description herein.

Server 500 provides information to advertiser user interface 502, and media producer interface 503 via a connection to network 501. Although the system is shown as four separate components, and, preferably in final form includes four separate components, the system can be a single computer without departing from the scope of the present invention. For example, all the auction and user data can be resident (stored) in memory of a single computer, and separate users can take turns using the computer while the auction takes place.

Server 500 can be software executed on a platform such as a minicomputer, a microcomputer, a UNIX™ machine, a mainframe computer, an Intel™ machine, an Apple™ machine, a PowerPC™ machine, or any other appropriate computer without departing from the scope of the present invention. In an exemplary embodiment, server 500 is a distributed server system set up for robustness in case one server fails. In another exemplary embodiment, server 500 is a World Wide Web (WWW) server, and network 501 is the Internet.

Advertiser user interface 502 and media producer interface 503 are typically websites supported conventionally by server 500, but the different user interfaces can be client application software installed on a separate machine without departing from the scope of the present invention. An interested advertiser can utilize advertiser user interface 502 to connect to server 500 and search for product placement opportunities, bid on product placement opportunities, search for media producers, and create profile information so that media producers can search for the interested advertiser using the system. Likewise, an interested media producer can utilize media producer interface 503 to connect to server 500 and create profile information so that advertisers can search for the interested media producer, can create a product placement opportunity to bid on, and can search for member advertisers of the system and invite them to participate in a public or a private auction.

FIG. 6 illustrates a schematic of an embodiment of a conventional server platform of the system shown in FIG. 5. The server includes central computer 600, an input device 601, an output device 602, a connection to network 501, memory component 603, and software modules 604, 605, 606, and 607, and database 608 resident on memory component 603.

Although the server is shown as four separate components, and in final form preferably includes at least four separate components, the server can be a single computer system without departing from the scope of the present invention. As shown, memory component 603 is coupled conventionally either externally or internally to central computer 600. Memory component 603 is typically a non-volatile memory storage device, such as a hard drive, disk drive, tape unit, Network Attached Storage (NAS) device, Storage Attached Network (SAN) device, RAID disk array, or optical disk array. Although typically a non-volatile memory storage device, memory component 603 can be any other memory device, such as flash memory or RAM or a floppy disk, without departing from the scope of the present invention. In an exemplary embodiment, memory module 603 is conventionally striped across a RAID disk array in a SAN environment for increased data access speeds and robustness.

Database 608 holds objects and information relating to all users of the system, and the auction bidding environment utilized by users of the system. Database 608 is typically created by a conventional database manager using conventional technologies such as relational architecture and SQL access, such as Microsoft™ SQL or Oracle™ DB. However, database 608 can be as simple as a series of files stored in a directory, with a text file listing filename locations without departing from the scope of the present invention. In one embodiment, database 608 is a combination of a conventional database manager, and an organized directory tree structure, where the database manager stores text information in the database itself, but stores multimedia information and other non-text information such as filename locations of files stored in an organized directory tree structure.

Typically, a user of the server utilizes input device 601 and output device 602 to load software modules 604, 605, 606, and 607. Although shown as four separate software modules, the software system can be one module, or a multitude of small modules without departing from the scope of the present invention. Software modules 604-607 will help facilitate user interaction with database 608.

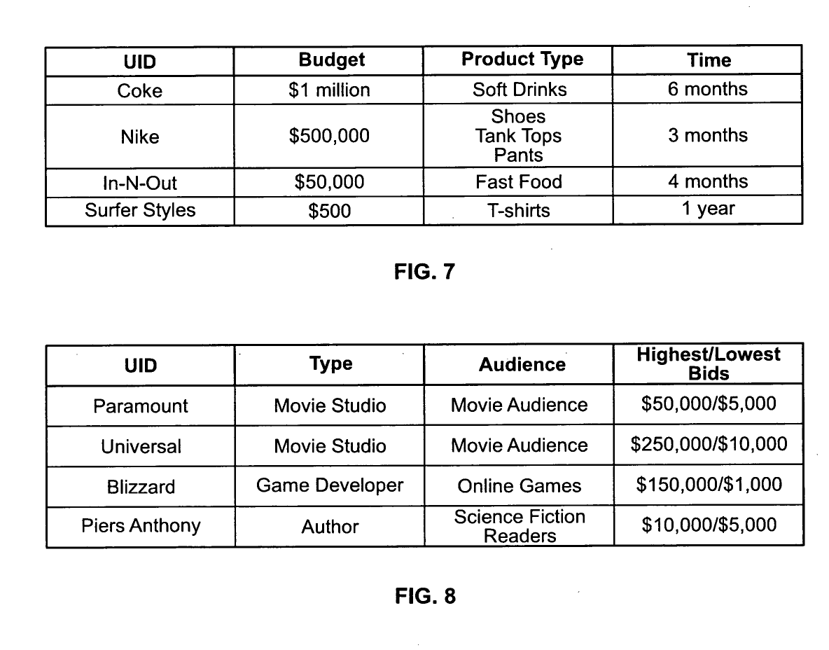

Database 608 can hold all the information in one table, or each item of information in a separate table, with all tables cross-referencing each other with unique identifiers. In an exemplary embodiment, database 608 is somewhere in the middle, with separate tables holding different information that can be accessed and searched by the column type, and cross-referenced using standard queries and join commands. Some embodiments of exemplary tables are shown in FIG. 7 to FIG. 10.

FIG. 7 illustrates an embodiment of a database table including advertiser information which is self-explanatory, each advertiser having one row in the table. Advertisers may wish to place their product type in the database, so media producers of product placement opportunities could search for the types of products they have available. If an advertiser sells clothing, they may wish to have one of the actors wear some of their most prominent and new clothing lines. If an advertiser sells cars, they may wish for a game developer to feature that car in a racing game. If an advertiser sells massage services, they may wish a character in a play to use their massage service during one of the scenes.

Although advertisers traditionally sell products and services, a product placement opportunity can be more than simply placing a product or service in a scene of produced media. For example, a poster on a wall, or a commercial playing on a television set in the background could also serve as an opportunity. Also, if a certain trademark is well-known, a mere mention of that trademark by a main character may be well worth paying for.

Advertisers also may wish to limit their availability for bidding on product placement opportunities by a certain time period, or a certain venue. For example, an advertiser may be promoting a new clothing line that will be debuting on a certain date. In such a scenario, that advertiser may wish to only purchase product placement opportunities that will be shown to an audience before the premiere, or perhaps only for a few months after premiering that product line.

While it may not seem advantageous at first for an advertiser to list his budget, an interested media producer may wish to search for advertisers who can meet their minimum quota or price point requirement. Additionally, an advertiser with a larger budget may be invited to more exclusive auctions, as media producers with access to this information could determine how serious an advertiser is to do business with that particular media company.

FIG. 8 illustrates an embodiment of a database table including producers of product placement opportunities.

Media producers of product placement opportunities can create a profile which advertisers could search for a little information on who they are bidding on. Some advertisers would be reluctant to bid on even the most promising script if the producer of the media is an unknown, or has little to no history. Additionally, the type of audience media producers could have a significant impact on whether or not an advertiser would want to bid on the product placement opportunity, as well as impact demand.

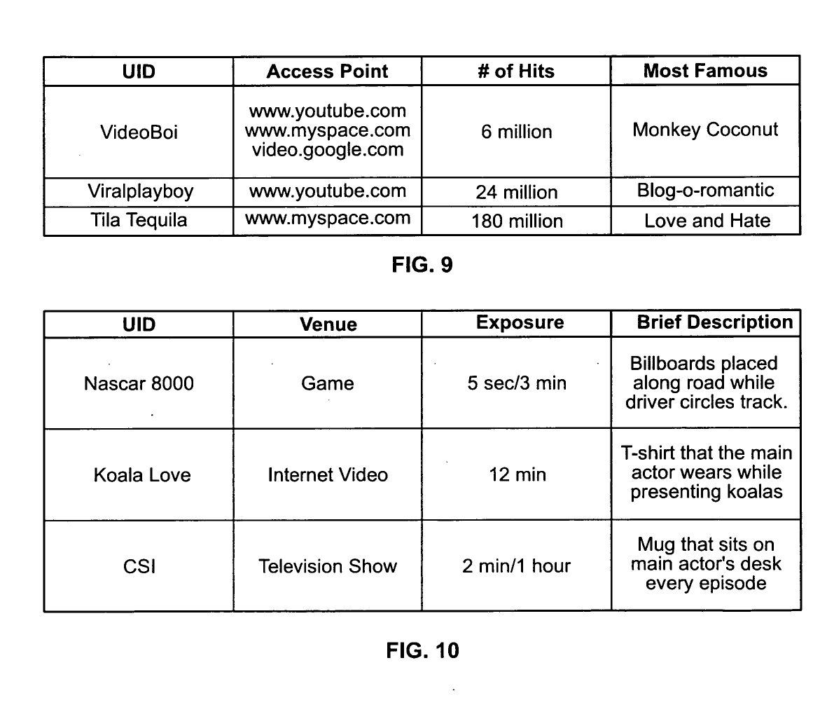

FIG. 9 illustrates an embodiment of a database table including specifically internet video producers of product placement opportunities.

Media producers of internet videos may have a separate table, or may simply have more fields that are filled out than other media producers. Detailed metric information can be collected cheaper and easier through electronic media that automatically leave a digital trail with every viewing, or every usage of the media. This additional metric information can be collected automatically by a service provider, and served to interested parties who want to know how successful and dependable a media producer of internet videos is. This additional metric information is especially important with media producers of internet videos, as oftentimes nobody has heard of the media producer before, or the media producer's history has been very short.

FIG. 10 illustrates an embodiment of a database table including product placement opportunities. Product placement opportunities can be entered into in the database in a variety of ways. One typical way would be to simply upload a storyboard, or a map, or a drawing of how the product placement opportunity would work. Another way would be to input detailed text information. In an exemplary embodiment, a media producer would input both types of information, not only to give a comprehensive view to advertisers who may potentially bid on those opportunities, but also to provide even more search terms for advertisers to find those opportunities with.

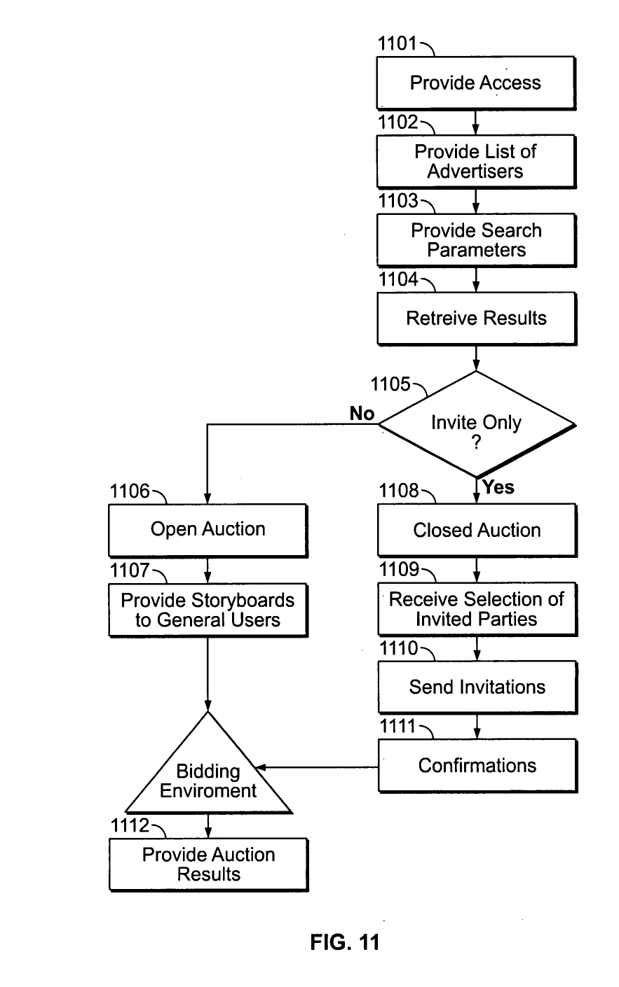

FIG. 11 is an illustration of a flow chart describing a process for a user, for example a media company, to access a database as described above containing advertisers' product information and auction product placement opportunities in accordance to an embodiment of the present invention.

The method is explained in the order shown below; however the following steps may be taken in any other conceivable sequence without deviating from the scope of the present invention.

The process illustrated by FIG. 11 generally includes providing the interested party, such as an entertainment media company, access to a database of advertisers and their products; providing search parameters and receiving a selection of products or advertisers from the media company; and providing an option for media companies auctioning product placement opportunities to engage in open auctions or closed auctions.

The first illustrated step 1101 includes of providing a user such as an entertainment company access to a database (discussed above) containing advertisers' information, including the types of products available for advertisement.

In step 1102, a list of products and advertisers is provided for the media company user. This list may be provided in alphabetical order, using images, or in any other format which may be used to present the information to a user.

In one embodiment, the list is a list of links to advertisers' products. For example and in no way limiting the scope of the present invention, each name of each advertiser is a link to a list of that advertiser's products, and each listed product contains a link to at least a description of the product and an image of the product that advertiser desires to advertise.

In step 1103, search parameters are provided for media company users so as to make navigation through the list of advertisers and products comprehensible, efficient, and focused.

In one embodiment, the list of advertisers may be searched by type of product, by genre, by trademark name, and by product category. However, the search parameters may be in any other format such as a Boolean search, or any other type of search parameters available to search databases. Once a user enters search parameters, the results are retrieved for user in step 1104.

In step 1105, a media company user is given the choice of engaging in an open auction where general users may bid on the media company user's product placement opportunities, or a closed auction where only privately invited users, for example specifically selected advertisers, are invited to place bids on the media company user's product placement opportunities.

Different steps may be taken depending on whether the auction media company user desires to engage their product placement opportunities on a closed or open auction. If an open auction is selected for one particular or a particular set of product placement opportunities, then steps 1106, 1107 and 1112 may be taken to complete the process of placing the opportunities for auction. However, if a closed auction is selected for one particular or a set of particular product placement opportunities, then steps 1108, 1109, 1110, 1111, and 1112 may be taken to complete the process of placing the opportunities for auction.

Now turning first to a discussion of the process for operating an open auction, step 1106 involves receipt of at least one product placement opportunity from the media company user. In one embodiment a story board where the at least one product placement opportunity is displayed is provided by the media company user.

In another embodiment, the story board may be provided by a third party or even the service provider holing the auction.

Once the product placement opportunities are received, they may be made available to general users by providing the story boards on a bidding environment in step 1107.

Once on the bidding environment, and after providing the terms and conditions of the auction (discussed above) the highest bid is received and auction results are provided to the media company user.

A few more steps may be required if a media company user desires to place its product placement opportunities on a closed auction. Turning first to step 1108, a selection of at least two invited parties is received from media company user. Additionally, in step 1109 product placement opportunities are also received from media company user for placement in bidding environment.

In step 1110, selected parties such as advertisers are sent an invitation along with some information regarding the placement opportunities. In one embodiment, each invited party receives a story board with each product placement opportunity displayed. In another embodiment each invited party receives a description of the product placement opportunity. In another embodiment, perhaps only some limited information is provided for invited parties. For example, and in no way limiting the scope of the present invention, a media company may only provide the names of the executive producer, director, and starting actors in a motion picture movie where product placement opportunities will be available, and disclose further information about each opportunity only during the actual auction.

After sending each selected invitee an invitation, in step 1111 confirmation or reservations are received from each invited party. Once this information has been obtained, the auction may be placed in a bidding environment (for example, as discussed above).

Again, as in an open auction, the final step 1112 (as illustrated in this flow chart) involves providing the media company user with the results of the auction.

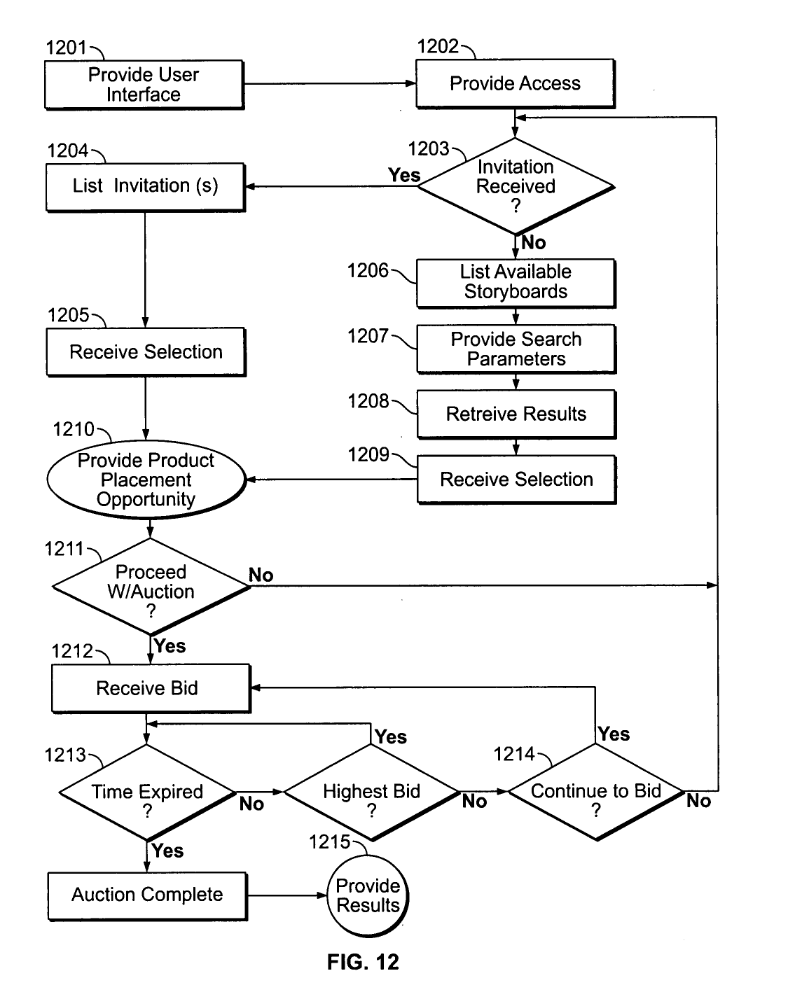

Now turning to FIG. 12, another flow chart illustrates a process for users, for example advertisers interested in marketing their products through product placement opportunities, to access a database of the opportunities and bid on auctions to have their products advertised.

The method is explained in the order shown below; however the following steps may be taken in any other conceivable sequence without deviating from the scope of the present invention.

The process illustrated by FIG. 12 generally includes providing access to a database containing product placement opportunities information; providing a list of invitations to bid on product placement opportunities; providing a list of available product placement auctions with search parameters; retrieving results of searched opportunities and providing selected opportunities for advertising users to bid on; providing a process for bidding in a selected auction; and providing advertising user with auction results.

Turning first to step 1201, a user, for example an advertiser, looking to market products using product placement opportunities, is provided a user interface and in step 1202 a user is provided access to a database where advertiser user may find product placement opportunities being auction.

In step 1203, an advertiser user is provided with a choice of viewing any invitations that advertiser user might have received from media company users to bid on product placement opportunities. Depending on whether advertiser user desires to view listed invitations or search for available product placement opportunities, a different sequence of steps may be taken at this point of the process. If advertiser user desires to view received invitations then steps 1204 and 1205 may be taken to provide product placement opportunity auctions available. If, on the other hand, advertiser user desires to search or view available product placement opportunity auctions on the database, then steps 1206, 1207, 1208, and 1209 may be taken to provide user with product placement opportunity auctions available.

If an advertiser user has been sent invitations from a user auctioning product placement opportunities, for example a media company user, then in step 1203 advertiser user is provided with a list of at least one invitation that user has received.

Turning first to step 1204, available invitations (if there is at least one invitation to participate in an auction) are provided to advertiser user. Then in step 1205, at least one selected invitation that user might be interested in viewing is received from user and retrieved in step 1210 (discussed below).

In case an advertiser user desires to view or search open auctions available, or has not received any invitations, steps 1206, 1207, 1208, and 1209 may be taken. Turning first to step 1206, a list of available product placement opportunities may be provided. Additionally, a comprehensible search engine with search parameters may be provided in step 1207 in order to provide user with a more focused and efficient search of the available auctions. Once selected, results are retrieved and provided for advertiser user in step 1209.

Once at least one invitation to an auction or at least one available auction has been selected by a user, at least one product placement opportunity associated with an auction is provided and displayed for user.

After viewing the information, user is provided with an option to proceed with the auction for the displayed product placement opportunity in step 1211. If the displayed opportunity is not attractive to advertiser user, then advertiser user may return to step 1203 to decide and view other available opportunities or invitations to actions for opportunities to advertise user's product.

Alternatively, user decides to bid on displayed opportunity and a bid is received from advertiser user in step 1212. In step 1213 a time limitation must be determined in order to either end the auction or continue allowing receipt of bids from user. If the time limitation has expired, then user is no longer allowed to submit any other bids, the auction is complete and only the last step 1215 may be followed. If the auction has time remaining, then a determination must be made of whether the user's last bid was the highest bid thus far in the auction. If the current bid received by user is the highest bid, then step 1213 is repeated until the completion of the auctioning or bidding period. If at any point before the completion of the auction, or bidding period, the user's current bid is no longer the highest bid (another user has a higher bid) then in step 1214 the advertiser user may be given an option to either continue bidding on the product placement opportunity or go back and look for other available opportunities.

Whether or not advertiser user has obtained the highest bid, as of the moment time expires, no more bids may be received from a user, the auction is completed and the results may be provided in step 1215.

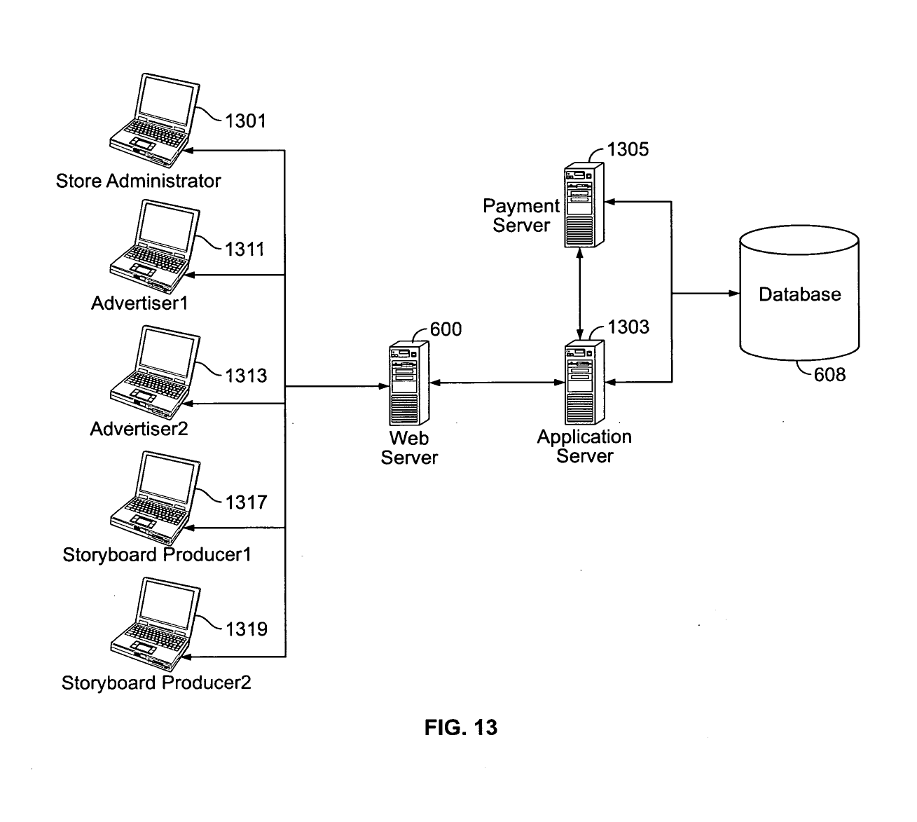

FIG. 13 is a schematic diagram illustrating another embodiment of a system for providing product placement opportunities in an auction environment. In this embodiment, advertisers via computers 1311, 1313 and media producers (storyboard producers) via computers 1317, 1319 can conventionally access a web server 600, or a cluster of web servers in order to access the auction website remotely. A system administrator (store administrator) 1301 can remotely administer the auction website on server 600 and can change parameters and variables of the various auctions, or user accounts. In one embodiment, the web server, or web server cluster, only serves simple HTTP requests and data, and acts as a communication conduit between the users of the system, and the application server 1303.

The application server 1303 itself will perform the major duties of accessing the database for input, output, and searches. It will also communicate with a separate conventional payment server 1305 which will be used to service automatic or manual payments made by users of the system. Either the application server 1303 can access the database 608, or the payment server 1305 can access the database, or both servers can access the database which will house information on the various users of the system, the auctions, and/or metric information collected by the media.

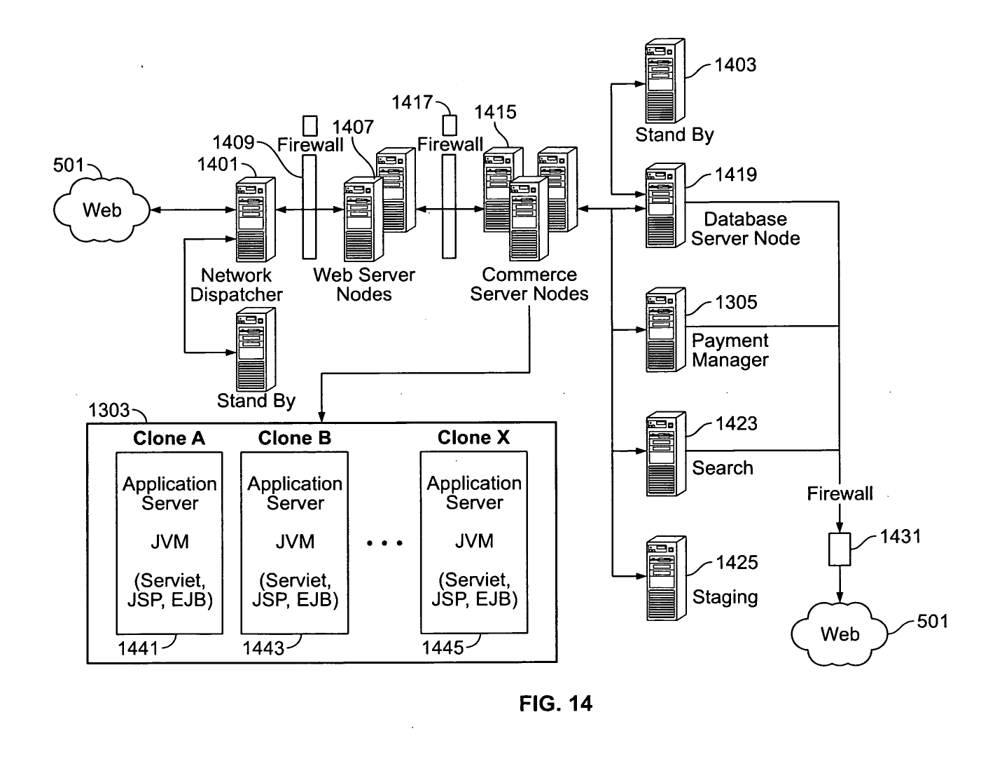

FIG. 14 is a schematic diagram illustrating yet another embodiment of a system for providing product placement opportunities in an auction environment.

In this embodiment, a conventional network dispatcher 1401 serves web content directly to users of the system via the web (Internet) 501. A standby network dispatcher 1403, or a series of standby network dispatchers, could be at the ready in case the primary network dispatcher 1401 fails, and/or goes offline. This network dispatcher 1401 simply handles the load for web content to travel from users to the actual system provider itself.

A conventional web server node, or a series of web server nodes 1407, can sit behind a conventional firewall 1409 to serve HTTP requests and responses. A conventional commerce server node, or a series of commerce server nodes 1415, can sit behind yet another firewall 1417 to serve applications. The firewalls 1409, 1417 may not be needed, but are recommended for security purposes. Also provided is the application server 1303 having in this case multiple instances, clone A 1441, clone B 1443, and clone X 1445. The database server node 1419 can conventionally house database application software, and access an associated database 608 which resides on an attached memory. In case the database application software goes down, or the server 1419 itself goes down, a standby server, or a series of standby servers, could be used. Separate computers 1305, 1423 respectively could also be used to send payment requests, and search the database itself. Should upgrades to the commerce server nodes 1415 occur, staging servers 1425 can be used as test nodes to gradually upgrade the backend.

All of the backend servers 1415, 1403, 1419, 1305, 1423, 1425 may be connected to the web 501 for administrative purposes via conventional firewall 1431, or can be completely cut off, depending on the security preferences of the system administrator.

This disclosure is illustrative and not limiting; further modifications will be apparent to those skilled in the art in light of this disclosure and are intended to fall within the scope of the appended claims.

What is claimed is:

1. A method comprising the acts of:
receiving a storyboard for a script;
receiving a description of a product placement opportunity in said storyboard;
providing said storyboard to an advertiser;
providing said description to an advertiser; and
receiving a bid for said product placement opportunity from said advertiser.

2. The method of claim 2, further comprising the act of:
providing software to a producer for creating said storyboard.

3. The method of claim 3, further comprising the acts of:
receiving a video from a producer of said video;
receiving a number of times said video has been provided to a viewer; and
providing said number of times to said advertiser.

4. A method comprising the acts of:
receiving information about an advertiser;
providing a producer of a storyboard said information;
receiving a request from said producer to inform said advertiser about said storyboard; and
providing said advertiser with information about said storyboard.

5. A method comprising the acts of:
receiving information about a video;
tracking tagged information associated with said video; and
providing said tagged information to an interested party.

6. The method of claim 4, wherein said tagged information comprises:
how said video was accessed by viewers;
how long an advertised product or service was shown in said video; and
how many times said advertised product or service was shown in said video.

7. A method comprising the acts of:
receiving a storyboard for a script;
receiving a description of an adspace in said storyboard;
providing said storyboard to an advertiser;
providing said description to an advertiser; and
receiving a bid for said adspace from said advertiser.

8. The method of claim 7, further comprising the act of:
providing to a producer software for creating said storyboard.

9. The method of claim 8, further comprising the acts of:
receiving a video from a producer of said video;
receiving a number of times said video has been provided to a viewer; and
providing said number of times to said advertiser.

10. A method comprising the acts of:
receiving information about an advertiser;
providing to a producer of a storyboard said information;
receiving a request from said producer to inform said advertiser about storyboard; and
providing said advertiser with information about said storyboard.

11. A method comprising the acts of:
receiving a product placement opportunity in a media;
providing information on said product placement opportunity to an advertiser;
receiving a bid on said product placement opportunity from said advertiser; and
matching said product placement opportunity with said advertiser.

12. The method of claim 1, further comprising the acts of:
creating an auction environment for multiple advertisers to bid on said product placement opportunity;
tracking a highest bid on said product placement opportunity; and
providing said highest bid to a creator of said product placement opportunity.

13. The method of claim 12, further comprising the acts of:
providing a plurality of bids in said auction environment to said creator; and
providing information on bidders who made said plurality of bids to said creator.

14. The method of claim 11, wherein receiving said product placement opportunity comprises:
receiving a summary of said media;
receiving a description of each product placement opportunity in said media; and
storing said summary and said description.

15. The method of claim 14, wherein said summary comprises a storyboard.

16. The method of claim 15, further comprising the act of providing software to create said storyboard.

17. The method of claim 14, wherein said media is a video game, and wherein said summary comprises a map of the terrain of said game.

18. The method of claim 12, wherein said auction is selected from a group consisting of:
a Dutch auction;
a sealed bid auction; and
an open cry auction.

19. A computer program for carrying out the method of claim 1.

20. A computer programmed to carry out the method of claim 1.

21. A method comprising the acts of:
an advertiser publishing a request for a product placement opportunity for a particular product together with an amount to be paid for the opportunity;
receiving in response to the publication a plurality of storyboards with the product placement therein; and
the advertiser selecting at least one of the storyboards for the product placement opportunity in a production associated with the selected storyboard, and paying for the opportunity.

22. The method of claim 21, wherein the publication includes a graphical representation of the product or an associated trademark which is the subject of the product placement opportunity, the graphical representation adapted to be downloaded by creators of each storyboard into the storyboard.

23. A system, comprising:
a server;
a memory, accessible by said server;
a database, stored in said memory, each entry of said database comprising:
an advertiser,
a product placement opportunity, and
a bid that said advertiser places on said product placement opportunity;
a bidding environment, enabling at least one advertiser to bid on each said product placement opportunity;
a first user interface for
enabling a producer to input said product placement opportunity into said database, and
enabling said producer to receive information on said bid; and
a second user interface for enabling said advertiser to bid on said product placement opportunity.

24. The system of claim 23, wherein said product placement opportunity comprises a motion picture.

25. The system of claim 23, wherein said product placement opportunity comprises a network television show.

26. The system of claim 23, wherein said product placement opportunity comprises a music video.

27. The system of claim 23, wherein said product placement opportunity comprises a theatrical production.

28. The system of claim 23, wherein said product placement opportunity comprises a book.

29. The system of claim 23, wherein said product placement opportunity comprises a movie theater.

30. The system of claim 23, wherein said product placement opportunity comprises a digital video uploaded to the Internet.

31. The system of claim 23, further comprising:
a search program to search for potential product placement opportunities.

32. The system of claim 31, wherein said search program comprises a Boolean search engine.

33. The system of claim 31, wherein said search program enables a user to search using a field selected from a group consisting of a type of product or service, an estimated date of publishing, a type of viewer, a party involved in a production, a length of product or service exposure, and a type of product or service use in said production.

34. The system of claim 23, further comprising:
a search program to search for potential advertisers.

35. The system of claim 34, wherein said search program comprises a Boolean search engine.

36. The system of claim 35, wherein said search program enables a user to search using a field selected from a group consisting of a type of product or service, a budget, and a type of viewer.

37. The system of claim 23, wherein said bidding environment comprises:
a period of time within which an advertiser is allowed to bid on said product placement opportunity; and
a presentation of said product placement opportunity.

38. The system of claim 37, wherein said bidding environment further comprises:
a storyboard representation of a video.

39. The system of claim 23, wherein said product placement opportunity comprises a game.

40. The system of claim 23, wherein said product placement opportunity comprises a radio show.

41. The system of claim 23, wherein said product placement opportunity comprises electronic media.

42. A method, comprising the acts of:
monitoring a digital video shared to a plurality of computers coupled via a network;
collecting metric information on said digital video when said digital video is accessed by one of said computers; and
reporting said metric information to an interested party.

43. The method of claim 42, further comprising the act of:
making available said digital video on said network.

44. The method of claim 42, wherein said monitoring comprises:
monitoring specific access points in said network where said digital video can be shared.

45. The method of claim 42, wherein said monitoring comprises:
monitoring all copies of said digital video on said network.

46. The method of claim 44, wherein said monitoring comprises:
monitoring the number of times said video has been accessed;
monitoring the number of times said video has been accessed through said specific access points; and
monitoring the types of users who use said specific access points.

47. The method of claim 42, wherein said digital video comprises a product placement advertisement.

48. The method of claim 47, wherein said monitoring comprises:
monitoring how long said product placement advertisement is shown.

49. The method of claim 48, wherein said monitoring further comprises:
monitoring how many times said product placement advertisement is replayed by the same user.

50. The method of claim 49, wherein said monitoring further comprises:
monitoring a type of user who watched said product placement advertisement.

51. A method comprising the acts of:
monitoring a digital video shared to a plurality of computers coupled via a network;
collecting analytics of said digital video when said digital video is accessed by one of said computers; and
reporting said analytics.

52. A computer program for carrying out the method of claim 42.

53. A computer programmed to carry out the method of claim 42.
